(19) United States
(12) Patent Application Publication
(10) Pub. No.: US 2002/0197064 A1
(43) Pub. Date: Dec. 26, 2002

(54) Portable audio/video output device and method of data abstraction thereto

(76) Inventors: Jeroen Geert Bijsmans, Oegstgeest (NL); Rachel Lucy Murphy, Bristol (GB); Christine Ching-Hui Chuang, Alhambra, CA (US)

Correspondence Address: HEWLETT-PACKARD COMPANY, Intellectual Property Administration, P.O. Box 272400, Fort Collins, CO, 80527-2400, US

(21) Appl. No.: 10/175,441

(22) Filed: Jun. 20, 2002

(30) Foreign Application Priority Data
Jun. 22, 2001 (GB) 0115298.2

(51) Int. Cl. H04N 5/76; H04N 5/225

(52) U.S. Cl. 386/96; 386/117

(57) ABSTRACT

A portable audio and/or video output device comprises display means, data storage means, and selection means. The storage means is arranged to store data and the display means are arranged to display a graphical representation indicative of some or all of the stored data. The selection means are arranged to select a portion of the data in response to an action executed by a user of the device viewing the graphical representation.

This invention relates to a portable audio/video output device. More particularly, it relates to a portable audio/video output device in which data to be stored upon, or output by, the device is selected pictorially.

The current methods of purchasing, for example, music involve complex interfaces either with machines, Internet shopping, or with people over the telephone or in a shop. This can be inconvenient particularly when engaged in active pursuits such as, for example, work, exercise or driving.

A further problem associated with most current portable audio/video output devices is that if, for example, a user forgets a particular piece of music and is away from their music collection there is no easy way for them to access that music.

It is an object of the present invention to, at least partly, ameliorate at least one of the above-mentioned problems/difficulties.

According to a first aspect of the present invention there is provided a portable audio or/and video output device comprising display means, data storage means and selection means, the data storage means being arranged to store audio or/and video data, the display means being arranged to display a group of individual pictorial representations, each representation being indicative of a portion of the data, the selection means being arranged to select a portion of the data in response to a user of the device selecting the pictorial representation which corresponds to the portion of data.

The first aspect of the present invention increases the ease of use of such devices by allowing the pictorial selection of data by a user. This removes the need to use text based descriptions of, for example, CD's or videos, and allows their selection by the choice of a pictorial representation of, for example, the artwork of the sleeve insert or cover, and each track, or scene, can have it's own icon or artwork associated with it.

It will, of course, be appreciated that the data storage means does not necessarily need to be physically located at the remote device. It could, for example, comprise a virtual store using storage provided remotely at, for example, a server, which is connected to the portable device across a network a combination of “physical” and “virtual” storage may be provided if desired.

A portable device as referred to herein typically means a hand held, pocket-sized and battery powered device.

The group of representations may include a primary pictorial representation and a plurality of secondary pictorial representations, in which each primary representation corresponds to a respective one, or more, secondary representations. The primary representation may be substantially centrally disposed of the subsidiary representations, which are correspondingly disposed substantially radially therefrom, for example, the secondary icons may be arranged in a circle around the centrally disposed primary icon. The selection means may be actuable to scroll through a selection of primary representations, in use. The primary representation and the corresponding secondary representations displayed upon the display means may vary, in use, in response to an input from a user of the device. In a most preferred arrangement only one primary representation and its associated secondary representation(s) may be displayed at any one time.

The primary representation may be artwork associated with an audio collection. The artwork may be identifiable as a part or a whole of that represented on an album/CD cover/insert. The secondary representations may be artwork associated with an audio track. The selection means may be actuable to highlight the representation corresponding to the data to be selected, in use.

The data storage means may be arranged to store any one, or combination, of the following: audio data, pictorial data, video data, textual data. In each case the data may comprise pre-recorded data, such as one or more music tracks. A set of tracks may be stored which form an album. There may be provided connection means. The connection means may be arranged to transfer data between the device and a network element, in use upon which the storage and data is provided. The first aspect of the present invention allows a user to access data, for example, music whilst remote from their music collection, which is mounted upon, for example, a server, the network element.

The display means may be a screen. The screen may be a microscreen. The microscreen may measure 5.5 mm or less×5.5 mm or less. The display means may include a magnifier typically between the microscreen and a user of the device. The microscreen may be any one of the following types of display; liquid crystal display (LCD), electroluminescent (EL), field emission display (FED), active matrix electroluminescent (AMEL), vacuum fluorescent (VF), vacuum fluorescent on silicon (VFOS), organic light emitting diodes (OLED), active-matrix organic light emitting diodes (AMOLED), active matrix liquid crystal display (AMLCD), liquid crystal on silicon (LCOS), micro-electrical-mechanical systems (MEMS). The use of a microscreen has the advantage that it is lightweight and can be incorporated readily into portable devices. Also, the use of a microscreen gives the effect of a large field of view for a small viewing area when viewed close to.

The screen may form part of a head set device. Alternatively, the screen may form part of a hand held device. The device may be capable of outputting any one or combination of video images, still images or audio signals. The device may include an MP-3 player. The device may support JPEG and/or MPEG or other suitable data compression techniques. Hand held, or in particular, head set devices increase the privacy of any selection and output of data as it is difficult for others to view the representation displayed on a small screen of such a device. The use of hand held devices or head sets that can support the common data compression techniques allows large amounts of data to be stored, in a form that makes access by the user convenient, than would otherwise be the case.

The data storage means may be any one, or combination, of RAM, read-write CD, DVD, magneto-optical disc, digital tape or magnetic disc media. Thus, the data can be stored on a medium that is convenient for the user. The data stored on the medium may be any one or combination of audio, video, still images or textual data. There may be provided a buffer memory. The buffer memory may be part of the storage device or may be provided separately, typically in the form of RAM. The buffer will typically be 1s×2s×3s×5s×10s or 25s×the data transfer rate between the device and the network element. Buffer memory allows data to be streamed into the device, via the connection means without the provision of a large amount of memory. The amount of buffer memory required is dependent upon the reliability of the network connection between the device and the network element, i.e. a reliable network connection requires less buffer memory than an unreliable connection.

The transfer of data between the device and the network element may be in the form of a stream of data. The streamed data may either, or both, played immediately or/and stored upon the data storage means. The portion of the streamed data may be stored within the buffer. The streaming of data allows the real time output of data received by the device, for example, the playing of a CD in real time.

The data transfer rate between the device and the network element may be any one of, or between any pair of the following, <5 kbps, 5 kbps, 9.6 kbps, 16 kbps, 32 kbps, 56 kbps, 64 kbps, 96 kbps, 112 kbps, 128 kbps, 2 Mbps, >2 Mbps. The variation of the data transfer rate, particularly when streaming, allows the quality of the output, in particular audio and video outputs, to be altered. For example, a data transfer rate of 32 kbps corresponds to a signal with better audio quality than an AM radio signal where as a data transfer rate of 8 kbps has an audio quality similar to that of a PSTN telephone connection and MPEG-4 video streaming requires a data transfer rate of only 5 kbps.

The pictorial representation may be an icon. The icon may be supplied with the data. Alternatively, the icon may be user generated, either at the device or at a network element. In the case of audio data, and in particular, but not exclusively, music data or video data the icon may be associated with a primary data storage medium which has the data stored thereon, for example a CD or DVD. The icon and the data may be transferred from the primary data storage medium to the device via the connection means in use. The primary data storage medium may be read by, and/or the data stored upon a network element and the data and icon transferred from the network element to the device via the connection means, in use. Thus, for example, an audio CD may be bought and the data content transferred to a server or PC, being mindful of copyright considerations, along with pictorial representations of the cover of the CD and each track on the CD. Pictorial representations are more easily and quickly recognised than textual descriptions.

The icon may be a representation of any one or combination of artwork from a CD sleeve insert, a pictograph indicative of a particular musical track, a pictograph indicative of an MP-3 collection, a pictograph indicative of a video film or a scene from a video film, a pictograph indicative of a collection of still images, a pictograph indicative of a still image.

The selection means may include a first switch arranged to cause the displayed pictorial representation to change. The selection means may further include a switch, which may be the first switch or an additional switch, arranged to confirm selection of a portion of the data. This allows pictorial representations of all of the data stored on the device to be scrolled/toggled through and a desired data portion selected when its pictorial representation is displayed.

The device may be provided with an output socket which can allow the device to be connected to any one, or combination, of the following, a display or screen, a loudspeaker, an amplifier or headphones. Alternatively or additionally the device may have an in-built loudspeaker or headphones. The first of these configurations allow the device to be used to, effectively, act as a server with selections being made in response to pictorial representations displayed on a remote screen and selected date output via a remote output device such as a screen or loudspeaker.

The network element may be any one, or combination of the following: a PC, a server, an MP-3 recorder/player, a minidisk recorder/player, a CD player/rewriter, a DVD player.

The transfer of data between the device and the network element may be in the form of a download of data to the data storage means, typically for retrieval at a later time.

The connection means may be a wireless network connection, for example, either a cellular communication transceiver or a wireless network transceiver. The wireless network transceiver may be either, or both, a Bluetooth transceiver or a wireless LAN transceiver. The wireless LAN transceiver may employ an IEEE802.11 data transfer protocol. Alternatively, the connection means may be a modem which may be connectable either via a wireless or a hardwired connection to a public switched telephone network (PSTN). The connection means may be a temporary hardwired network connection. The connection means may, in use, connect to any one, or combination of the following: LAN, MAN, WAN, intranet, PSTN, intranet, extranet, internet or the Internet. The connection means may be any suitable radio frequency transceiver.

A variety of connection means benefits usage, particularly for streaming, as they enable the device to switch from cellular data transfer to wireless data transfer, where possible, in order to maximise the data transfer rate.

According to a second aspect of the present invention there is provided a data storage means adapted for use with a portable device according to the first aspect of the present invention bearing a first data file having a second data file associated therewith, the second data file being displayable upon the display means of the device as a pictorial representation indicative of the contents of the first data file.

The first data file may be an audio data file. The first data file may be a video data file. The data storage means may be any appropriate form of memory appropriate to the form factor of the portable device. Magnetic, optical or magneto-optic disks are an appropriate choice, particularly for larger form factors, as are flash memory and other semiconductor memories (either write-only or rewriteable), particularly for smaller form factors. Examples of data storage means suitable for appropriate embodiments are CD, Magnetic disc, Mini-disc, Magneto-optical disc, Flash card, SRAM, E²PROM, DVD, MultiMedia Memory Card, Secure Digital Card, Memory Stick, SmartMedia Card, though it will be appreciated that other conventional or new storage technologies could also be used.

According to a third aspect of the present invention there is provided a data storage means adapted for use with an audio output device containing encoded audio data and at least one encoded pictorial representation which is indicative of the encoded audio data, the audio output device having display means arranged to display, in use, the at least one pictorial representation.

The data storage means may contain a primary encoded pictorial representation and a plurality of encoded secondary pictorial representations, in which each primary representation corresponds to one or more of the secondary representations. The primary encoded pictorial representation may be artwork identifiable as the whole or a part of a piece of the audio data. The data storage means may include a case having a label or insert having artwork identifiable as the source of the primary pictorial representation printed on it.

The data storage means may be any appropriate form of memory appropriate to the form factor of the portable device. Magnetic, optical or magneto-optic disks are an appropriate choice, particularly for larger form factors, as are flash memory and other semiconductor memories (either write-only or rewriteable), particularly for smaller form factors. Examples of data storage means suitable for appropriate embodiments are CD, Magnetic disc, Mini-disc, Magneto-optical disc, Flash card, SRAM, E²PROM, DVD, MultiMedia Memory Card, Secure Digital Card, Memory Stick, SmartMedia Card, though it will be appreciated that other conventional or new storage technologies could also be used.

According to a fourth aspect of the present invention there is provided a method of data abstraction comprising the steps of:

i) assigning a pictorial representation to data stored on a network element;

ii) connecting a mobile device to the network element;

iii) displaying the pictorial representation on a display means of the mobile device;

iv) navigating a plurality of pictorial representations;

v) selecting a pictorial representation; and

vi) downloading the data to which the pictorial representation is assigned to the mobile device.

The method may include the step of providing data in the form of audio data files. The method may include the step of providing data in the form of video data files.

The method may include the step of providing a microscreen within the device upon which the pictorial representations are displayed.

The method may include the step of displaying a primary pictorial representation and a plurality of secondary pictorial representations wherein the secondary pictorial representations denote subsidiary data sets of the data set of which the primary pictorial representation is indicative. The method may include the step of scrolling through the pictorial representations. The method may include the step of displaying a primary pictorial representation and a plurality of secondary pictorial representations radially disposed therefrom wherein the radially disposed secondary pictorial representations denote subsidiary data sets of a data set of which the primary pictorial representation is indicative. The method may include the step of streaming data from the network element to the mobile device.

The method may include the step of providing any one, or combination, of the following at either or both of the portable device and the network element: a cellular transceiver, a wireless LAN transceiver, an infra-red transceiver, a USB connector, a Bluetooth transceiver any other convenient telecommunication means. The method may further include connecting the device and the network element via any of the aforementioned means.

The method may include the step of providing the network element in the form of any one, or combination of, the following: a PC, a server, a CD player/writer, a minidisk recorder/player, an MP-3 recorder/player, a DVD player.

The microscreen may typically measure 5.5 mm or less×5.5 mm or less. The microscreen may be provided in the form any one of the following types of display; liquid crystal display (LCD), electroluminescent (EL), field emission display (FED), active matrix electroluminescent (AMEL), vacuum fluorescent (VF), vacuum fluorescent on silicon (VFOS), organic light emitting diodes (OLED), active-matrix organic light emitting diodes (AMOLED), active matrix liquid crystal display (AMLCD), liquid crystal on silicon (LCOS), micro-electrical-mechanical systems (MEMS). There may be provided a magnifier, typically between the microscreen and a user of the device.

The method may include the step of storing the data on a storage device within the mobile device. The method may include the step of streaming data from the network element to the mobile device and may further include outputting the data from the device without storing the data.

The method may include the step of outputting the data from the device via any one, or combination, of the following: headphones, an amplifier, a screen, a loudspeaker.

According to a fifth aspect of the present invention there is provided a first data set encoding a pictorial representation that is indicative of the content of a second data set wherein the first data set is an encoding of the whole or a portion of artwork associated with a collection of audio recordings.

The second data set may be a listing of the recordings of the collection of audio recordings. The second data set may be at least one portion of said collection of audio recordings. The first and second data sets may be arranged to be stored upon a data storage medium. The data storage medium may be readable by a mobile device in accordance with the first aspect of the present invention.

The artwork may comprise an album sleeve or a CD insert.

According to a sixth aspect of the present invention, there is provided a network element configured to co-operate in the execution of the method of the fourth aspect of the present invention.

According to a seventh aspect of the present invention there is provided a program storage medium readable by a device and encoding a program of instructions capable of causing the device to operate as a device according to either the first or sixth aspects of the present invention.

According to an eighth aspect of the present invention there is provided a program storage medium readable by a device and encoding a program of instructions for executing a method according to the fourth aspect of the present invention.

According to a ninth aspect of the present invention there is provided a data carrier carrying a first portion of data and a second portion of data corresponding to a pictorial/pictorial representation of the first portion of data when displayed on a screen.

The invention will now be described, by way of example only, with reference to the accompanying drawings in which:

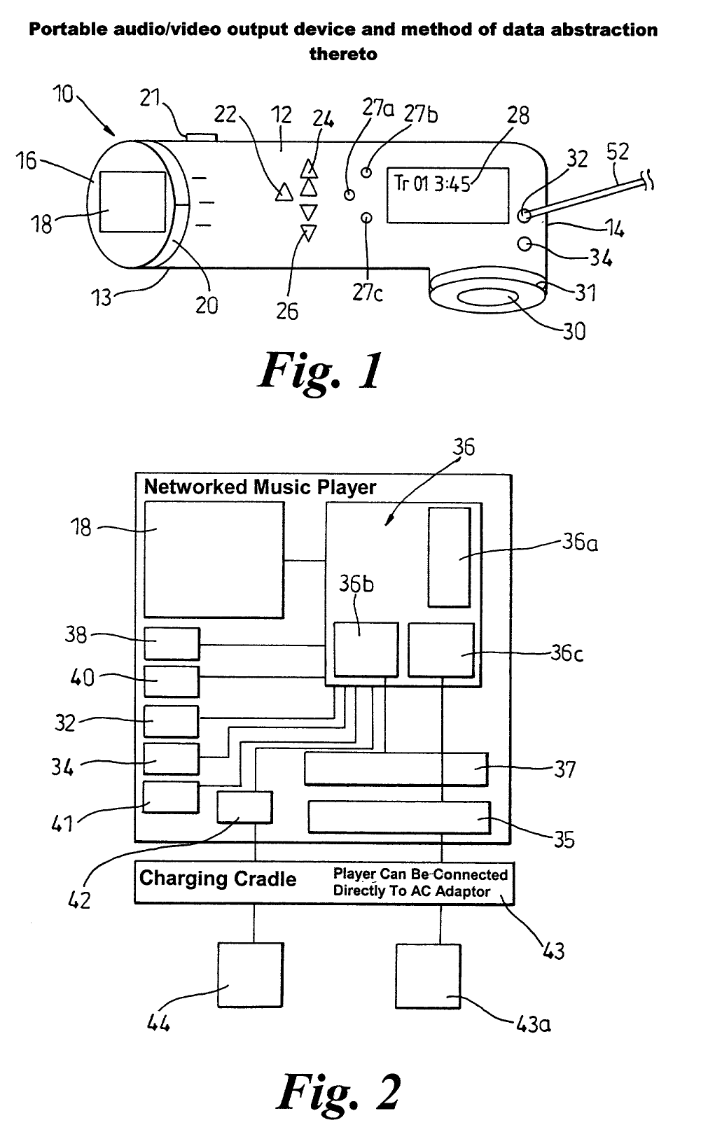

FIG. 1 is a perspective representation of a portable data output device according to the first aspect of the present invention;

FIG. 2 is a schematic representation of the internal layout of the device of FIG. 1 and a charging cradle arranged to receive the device;

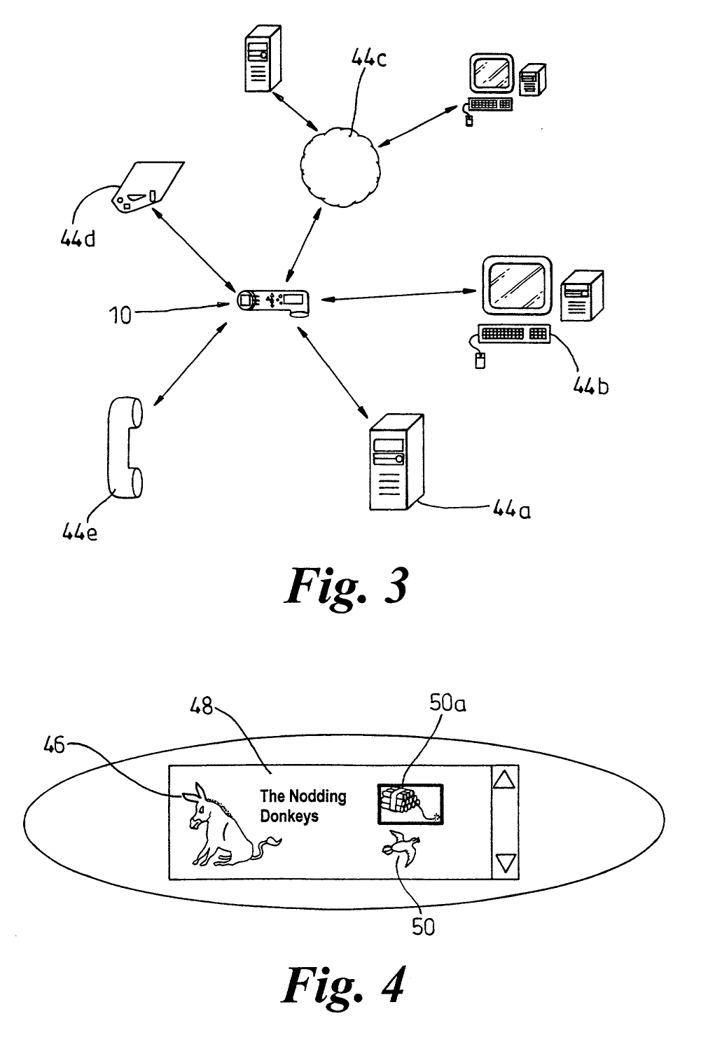

FIG. 3 is a schematic representation of the device of FIG. 1 and possible devices to which it may be connected for the upload/download of data;

FIG. 4 is a representation of an eyepiece and microscreen of the device, showing icons representing data, of FIG. 1;

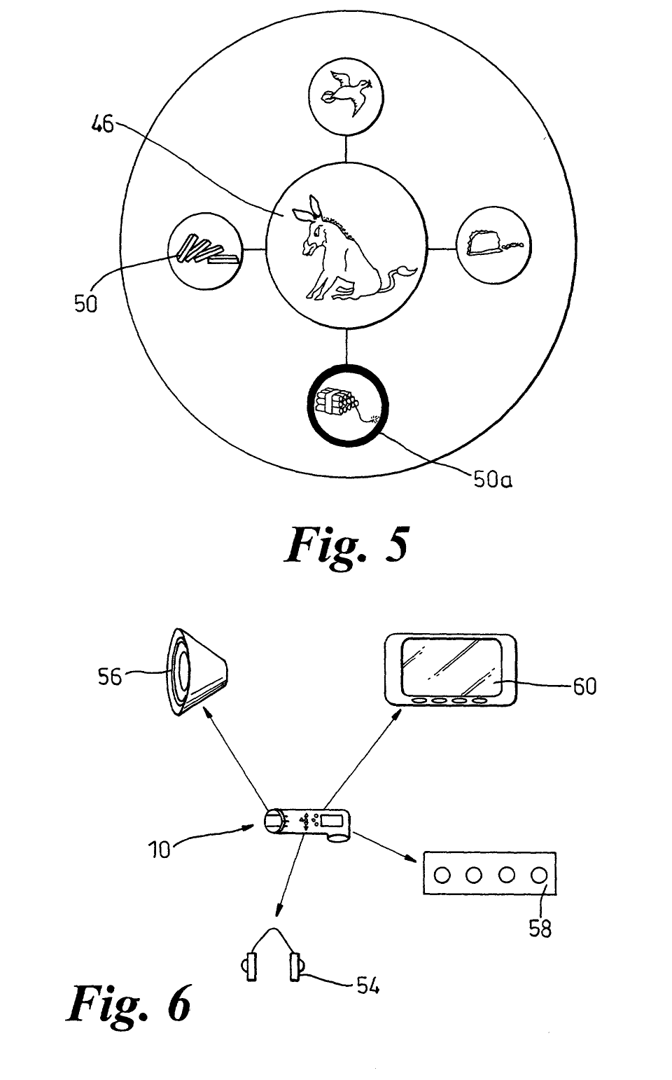

FIG. 5 is a representation of the eyepiece and microscreen of FIG. 4 with an alternative arrangement of the icons;

FIG. 6 is a schematic representation of the device of FIG. 1 and possible devices to which it may be connected for data output; and

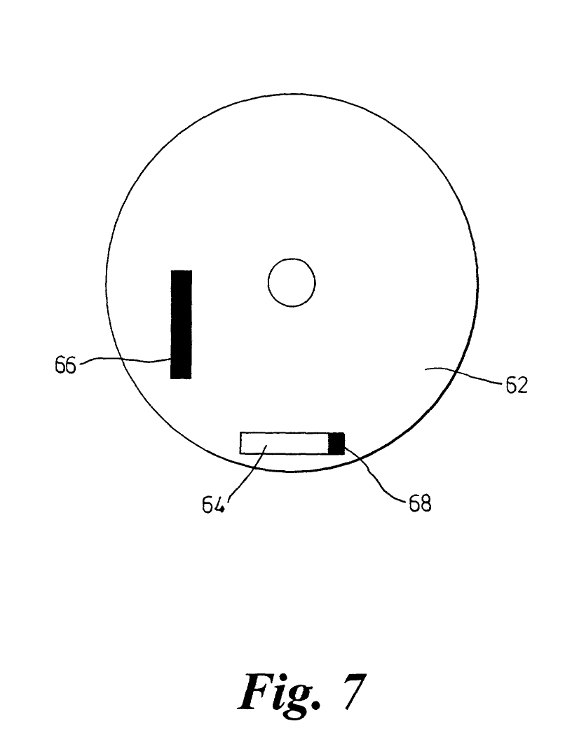

FIG. 7 is a schematic representation of a CD from which data can be downloaded onto the device.

A music player 10, as shown in FIG. 1, comprises an L-shaped cylindrical body 12 of substantially circular cross section having a long leg 13 and a short arm 14. The body 12 includes an eyepiece 16 at a free end of the leg 13 that has a microscreen 18 mounted therein. An annular mode selector 20 is located in a groove about the body 12 adjacent the eyepiece 16. A browse button 21 is mounted in the body 12. Play and pause, skip forward and skip back buttons 22, 24, 26 are mounted about the body 12. Further control buttons 27a-c are located adjacent the skip buttons 24, 26 and typically control volume and other functions. A display 28, typically on LCD display, which displays the track number and volume level is situated towards the end of the leg 13 which is remote from the eyepiece. A selector button 30 and a toggle switch 31 are located at a free end of the arm 14. An input/output socket 32 and an output socket 34 are located on the leg 13 towards the arm 14.

Referring now to FIG. 2, the body 12 contains a the microscreen 18, the input/output socket 32, battery 35, a processor 36, a cellular transceiver 38, a network transceiver 40, an infra-red transceiver 41 and a connector 42.

The processor 36 includes a storage device 36a, typically a block of non-volatile memory which may have a section designated as buffer memory, a user interface (UI) management unit 36b and a power management unit 36c. The management unit 36b manages the incoming signals from/to the input/output units of the player 10. The power management unit 36c regulates power supplied to the players electronics in order to maximise battery lifetime.

The cellular transceiver 38 is configured to use known, cellular telecommunications standards such as, for example, GSM or UMTS. The network transceiver 40 will be configured to use high speed data transfer protocols such as for example, 802.11 or Bluetooth and can therefore act as an LAN transceiver or a Bluetooth transceiver as required. The infra-red transceiver 41 may act as a receiver for infra-red remote control signals.

A charging cradle 43 has connections to an a.c. adaptor 43a and a music storage device 44. The player 10 is seated in the cradle 43 when a user wishes to recharge the battery 35. The battery 35 connects with the adaptor 43a via the cradle 43 so as to recharge the battery 35, in use. It will be appreciated that the adaptor 43a can be directly connected to the player 10 in order to recharge the battery 35.

The connector 42 co-operates with a connector upon the cradle 43 to place the device 44 in communications with the player 10. This allows the download/upload of data to/from the player 10 as will be described hereinafter. It will be appreciated that the device 44 can be connected directly to the player 10 via the connector 42 or the input/output socket 32. The player 10 can contain USB compatible hardware and software in which case the connector 42 and socket 32 can be different connection points of a USB cable. It will further be appreciated that only a single connection to the player 10 need be provided to carry both data and power.

It will also be appreciated that the player 10 need not be monocular but may be binocular.

In use, music files are stored on the music storage device 44 which is remote from the player 10. Typical devices include a server 44a, a PC 44b, the Internet 44c, a CD player 44d or PSTN download 44e. Further possible music storage device arrangements include a PC connected to a CD player/writer, an MP3 player/recorder and/or DVD player. Alternatively the storage device may be a stereo system (e.g. hi-fi, midi or mini system) connected to a CD player/writer, an MP3 player/recorder and/or DVD player. A user of the player 10 rotates the annular mode selector 10 to a ‘download’ position. This enables the LAN transceiver 40 which polls its surroundings to ascertain if there is a suitable device 44 having a LAN transceiver, for example, a server 44a within connection range. Provided that a server 44a is within range the LAN transceiver 40 established a connection with the server 44a and accesses the music files resident upon the server 44a. The typical connection range of a wireless LAN is a few tens of metres.

A folder upon the server 44a is used to represent an album, or an artists work and will have an icon 46 associated with it and there may also be text 48 associated with the icon 46. The icon 46 will typically be a representation of artwork from the album's cover or a CD's insert booklet.

A cluster of icons 46 are displayed on the microscreen 18 and are navigated through using the skip forward and skip backward buttons 24, 26. The browse button 21 skips between clusters. This enables the browsing of a large collection of albums/CD's arranged in clusters. The selector button 30 is depressed to select an album when its icon is highlighted.

A sub-icon 50 that represents a music file is displayed upon the microscreen 18. Each file on the server 44a represents a track and has a different sub-icon 50 associated with it. Each sub-icon will typically be a representation of artwork from an album or CD's insert sleeve. Alternatively, it may be a representation of artwork commissioned especially for use with the music player 10.

The user navigates through the folders and files on the server 44a using the toggle switch 31 and/or the skip forward and skip back buttons 24, 26. The icon 46 or sub-icon 50 corresponding to a directory or file will be displayed on the screen as the user navigates through the files stored on the server 44a.

FIG. 4 shows one possible display of icon 46 and sub-icons 50 wherein the icons 46/sub-icons 50 are scrolled through. An alternative icon display is shown in FIG. 5 wherein the icon 46 acts as a hub from which the sub-icons 50 radiate. The highlighted sub-icon 50a corresponds to the data that can be selected for download.

Should the user decide to store a file in the storage device 36a, they depress the selector buttons 30 and the file corresponding to the sub-icon 50 displayed on the microscreen 18 are downloaded over the network connection into the storage device 36a for immediate or later use. It is possible to select either a complete album or an individual track for download.

Rotating the selector 20 to a stream position initiates a scan by the player 10 for a network connection with an adequate data transfer rate to allow streaming of data. The selector 20 has a number of streaming selection positions indicative of the type of data, and therefore the required connection data transfer rate, to be streamed, e.g. MPEG-4 video streaming 4 kbps compared to CD quality stereo sound 128 kbps.

If a network connection between the server 44a and the player 10 has an appropriate data transfer rate is established the user can listen to the file by using the play buttons 22 to activate data streaming via the buffer portion of the storage device 36a. If a network connection with an adequate data transfer rate for streaming of data cannot be established the data must be downloaded as described hereinbefore. Stored tracks are played by the user rotating the selector 20 to a play position and using the play and skip buttons 22 and altering the volume using, for example, the control buttons 27b, 27c.

As the storage device 36a has limited capacity, one of the control buttons, for example button 27a, is configured to upload files, icons 46 and sub-icons 50 from the player 10 to the server 44a. This requires confirmation by depressing the selector button 30 when the sub-icon 50 corresponding to the file to be uploaded is displayed. 1 GB is typically required to store twenty five albums.

If the server 44a is networked the user can access any files that are available over the network, for example, on the Internet.

If a suitable server 44a is not within connection range of the player 10, or if after surveying the icons 46 and sub-icons 50 available from the server 44a the file that the user desires is not found, the player 10 can use the cellular transceiver 38 to access a device 44, for example a resource hosted on a PC 44b via the Internet 44c.

The player 10 may autodial a stored cellular identifier or may prompt the user via the display 28 to input a cellular identifier by using the skip forward and skip backward buttons 24, 26.

The user selects and downloads desired tracks in a similar manner to that described hereinbefore for the access of files over a LAN. However, due to the limited data transfer rates of cellular networks high data transfer rate streaming of data over a cellular network is not currently practicable although it is envisaged that it will become so in the future.

Alternatively, the player 10 is connected to a device 44 via a connecting cable 52 via the input/output socket 32. A USB cable digital connection is preferred as it has a higher data transfer rate (12 Mbit/s or 1.5 Mbit/s) than, for example a serial cable (0.115 Mbit/s). If the cable 52 is an analogue cable it will be used in conjunction with an analogue to digital converter (ADC) (not shown) within the player 10. In a further alternative, the player 10 is connected to the device 44 via the connector 42 as discussed hereinbefore.

The user selects and downloads desired tracks in the same manner as that described hereinbefore for the access of files over a LAN. Uploads from the player 10 can be executed via the cable 52.

The output socket 34 is used to output either audio or a combination of audio and video signals to, for example, headphones 54, a loudspeaker 56, an amplifier 58 or a screen 60 (such as a conventional television). This output may use standard A/V cabling.

The output of audio signals via headphones 54 allow for the private listening of music whereas the output of audio signals to a loudspeaker 56 or amplifier 58 results in a less personal communication of the music. The use of Bluetooth in both the player 10 and the headphones 54 allows a user to connect their headphones 54 wirelessly to the player 10 thereby increasing user mobility and freedom.

The connection of the player 10 to the screen 60 allows the icons 46 and sub-icons 50 to be displayed on a larger scale which allows for selection of music by a group of users or by a user with impaired vision.

The use of Bluetooth in the player 10 and the screen 60 allows wireless connection therebetween.

It is envisaged that a music CD 62 will be supplied with music files 64, an icon file 66 corresponding to the title, author etc, of the CD and sub-icon files 68 corresponding to the tracks thereupon. The icon files 66 and sub-icon files 68 would be removed and stored either by the device 44 if stored thereupon or by the player 10 if the files 64 are transferred directly thereto.

It will be appreciated that the present invention may be applied to any music player, for example a CD player, a car stereo, a mini-disc player, a hi-fi system or a jukebox.

It will be further appreciated that the downloading of data onto the player 10 may involve the purchasing of the data corresponding to the music and the icon either separately or together. The purchase may be made over the Internet, via a cellular link or via a PSTN using a credit or debit card.

It will still further be appreciated that the present invention is also applicable to the selection display and viewing of video data with the microscreen 18 being used as a video screen and the player 10 is connectable to a screen 60 to display the video data. This is particularly applicable to streamed data, for example, in aircraft where a number of films could be unicast, broadcast or multicast within a cabin for passengers to view as in flight entertainment. As the number of times a data file is accessed is logged this would allow the copyright owner to charge per viewing of the files.

1. A portable device for reproduction of at least one of audio data and visual data comprising display means, data storage means and selection means, said data storage means being arranged to store audio or/and video data, said display means being arranged to display a group of individual pictorial representations, each of said representations being indicative of a portion of said data, said selection means being arranged to select a portion of said data in response to a user of said device selecting at least one of said pictorial representations which corresponds to said portion of said data.

2. A portable device according to claim 1 wherein said storage means is physically located at said portable device.

3. A portable device according to claim 1 wherein said data storage means includes an area of memory remote of said portable device connected to said portable device across a network.

4. A device according to claim 1 wherein said group of representations includes a primary pictorial representation and a plurality of secondary pictorial representations, wherein each primary representation corresponds to a respective at least one of said secondary representations.

5. A device according to claim 1 wherein said primary representation is centrally disposed of said secondary representations which are correspondingly disposed radially therefrom.

6. A device according to claim 4 wherein said primary representation and said corresponding secondary representations displayed upon said display means vary, in use, in response to an input from a user of said device.

7. A device according to claim 4 wherein only a single primary representation is displayed at any one time.

8. A device according to claim 5 wherein said primary representation is artwork associated with an audio collection.

9. A device according to claim 8 wherein said artwork is that represented on an album/CD cover/insert of said audio collection.

10. A device according to claim 8 wherein said secondary representations are artwork associated with an audio track.

11. A device according to claim 1 wherein said selection means is actuable to highlight a one of said representations corresponding to said data to be selected, in use.

12. A device according to claim 1 wherein said data storage means is arranged to store at least one of: audio data, pictorial data, video data, textual data.

13. A device according to claim 1 wherein there are provided a connection means arranged to transfer data between the device and a network element, in use.

14. A device according to claim 1 wherein said display means is a micro screen.

15. A device according to claim 14 wherein said microscreen is an LCD device.

16. A device according to claim 1 wherein said display means includes a magnifier.

17. A data storage means adapted for use with a portable device for reproduction of at least one of audio data and visual data comprising display means and selection means, said display means being arranged to display a group of individual pictorial representations, each of said representations being indicative of a portion of said data, said selection means being arranged to select a portion of said data in response to a user of said device selecting at least one of said pictorial representations which corresponds to said portion of said data, said data storage means being arranged to store audio or/and video data and bearing a first data file having a second data file associated therewith, the second data file being displayable upon the display means of the device as a pictorial representation indicative of the contents of the first data file.

18. A data storage means according to claim 17 wherein said first data file is an audio data file.

19. A data storage means according to claim 17 wherein said first data file is a video data file.

20. A data storage means according to claim 17 wherein the data storage means is any one of an optical disk, a magnetic disk, a magneto-optical disk, a flash memory or semiconductor memory.

21. A data storage means adapted for use with an audio output device containing encoded audio data and at least one encoded pictorial representation which is indicative of the encoded audio data, the audio output device having display means arranged to display, in use, the at least one pictorial representation.

22. A data storage means according to claim 21 wherein said data storage means contains a primary encoded pictorial representation and a plurality of encoded secondary pictorial representations, in which each primary representation corresponds to one or more of the secondary representations.

23. A data storage means according to claim 22 wherein said primary encoded pictorial representation is identifiable as a whole or a part of a piece artwork associated with an audio collection.

24. A data storage means according to claim 23 wherein said artwork is that represented on an album/CD cover/insert.

25. A data storage means according to claim 23 wherein said encoded secondary representations are artwork associated with an audio track.

26. A data storage means according to claim 21 wherein said data storage includes a case having a label or insert having artwork identifiable as the source of the primary pictorial representation printed on it.

27. A data storage means according to claim 21 wherein the data storage means is any one of an optical disk, a magnetic disk, a magneto-optical disk, a flash memory or semiconductor memory.

28. A method of data abstraction comprises the steps of:
i) assigning a pictorial representation to data stored on a network element;
ii) connecting a mobile device to said network element;
iii) displaying the pictorial representation on a display means of said mobile device;
iv) navigating a plurality of pictorial representations;
v) selecting a pictorial representation; and
vi) downloading data to which said pictorial representation is assigned to said mobile device.

29. The method according to claim 28 including the step of providing data as audio data files.

30. The method according to claim 28 including the step of providing data as in the form of video data files.

31. The method according to claim 28 including the step of providing a microscreen within said device upon which said pictorial representations are displayed.

32. The method according to claim 26 including the step of displaying a primary pictorial representation and a plurality of secondary pictorial representations wherein said secondary pictorial representations denote subsidiary data sets of said data set of which said primary pictorial representation is indicative.

33. The method according to claim 29 including the step of scrolling through said pictorial representations.

34. The method according to claim 29 including the step of displaying a primary pictorial representation and a plurality of secondary pictorial representations radially disposed therefrom wherein said radially disposed secondary pictorial representations denote subsidiary data sets of a data set of which said primary pictorial representation is indicative.

35. The method of claim 28 including the step of streaming data from said network element to said mobile device.

36. A first data set encoding a pictorial representation that is indicative of the content of a second data set wherein said first data set is an encoding of at least a portion of artwork associated with a collection of audio recordings.

37. A data set according to claim 36 wherein said second data set is a listing of recordings of said collection of audio recordings.

38. A data set according to claim 36 wherein said second data set is at least one portion of said collection of audio recordings.

39. A data set according to claim 37 wherein said first and second data sets are arranged to be stored on a data storage medium.

40. A data set according to claim 39 wherein said data storage medium is readable by the mobile device of any one of claims 1 to 15.

41. A data set according to claim 37 wherein said first data set is an encoding of a whole or a portion of an album cover or CD insert.

42. A portable device for reproduction of audio data comprising a display, a memory and a user interface, said memory being arranged to store audio data, said display being arranged to display a group of individual pictorial representations, each of said representations being indicative of a portion of said audio data, said user interface being arranged to select a portion of said audio data in response to a user of said device selecting at least one of said pictorial representations which corresponds to said portion of said audio data.
